(19) United States
(12) Patent Application Publication
(10) Pub. No.: US 2010/0157609 A1
(43) Pub. Date: Jun. 24, 2010

(54) BRIGHTNESS ENHANCEMENT FILM

(76) Inventors: Yii-Der WU, Kaohsiung (TW); Chi-Chang Hsieh, Taichung (TW)

Correspondence Address: Muncy, Geissler, Olds & Lowe, PLLC, 4000 Legato Road, Suite 310, FAIRFAX, VA, 22033, US

(21) Appl. No.: 12/344,133

(22) Filed: Dec. 24, 2008

(51) Int. Cl. F21V 33/00

(52) U.S. Cl. 362/360

(57) ABSTRACT

A brightness enhancement film includes a substrate, a plurality of light-gathering units, and a plurality of micro-lenses. The substrate includes a first surface and a second surface that is opposite the first surface. The light-gathering units are mounted on the first surface, with the light-gathering units being aligned and spaced from each other in a first direction to form columns of the light-gathering units and the columns being arranged in a second direction to form a matrix of the light-gathering units, with each of the light-gathering units including a top face and a plurality of stepped portions on a peripheral surface of the light-gathering unit between the top face and the first surface. And the micro-lenses mounted on the first surface, with each of the micro-lenses being located between two adjacent light-gathering units in the first direction and between another two adjacent light-gathering units in the second direction.

### BACKGROUND OF THE INVENTION

1. Field of the Invention

The present invention relates to an optical film and, more particularly, to a brightness enhancement film.

2. Description of the Related Art

Brightness enhancement films, which are main components of backlight module structures, have become the main developing objects due to rapid development of the display industry. Taiwan Utility Model No. M330483 discloses upper and lower faces. The upper face includes a plurality of parallel microstructures each having a top face and a diffractive area surrounding the top face. The diffractive area includes a plurality of stepped sections on a curved surface. The stepped sections are symmetrically arranged relative to a central line passing through an apex of the curved surface and have identical or different heights. By such an arrangement, the incident light diffuses outward through the stepped sections, and a diffusion effect is obtained on the surface of the brightness enhancement film. However, the parallel microstructures create an orientation such that the light-gathering uniformity is low. To solve this problem, two brightness enhancement films are overlapped and perpendicular to each other. However, the optical diffusion effect is not satisfactory, so that a layer of diffusion film has to be disposed between the two brightness enhancement films, leading to an increase in the costs and in the overall thickness. Furthermore, light is liable to leak through gaps between adjacent microstructures, leading to adverse affect to the brightness.

Taiwan Patent Publication No. 200643459 (U.S. Pat. No. 7,416,309) discloses an optical film having a first surface disposed to receive light from the light source and a second surface facing away from the light source. The second surface includes a two-dimensional array of closely packed substantially hemispherically-shaped protrusions including larger protrusions and smaller protrusions located on the areas left void by the larger protrusions. However, the uniformity of the outgoing light is not satisfactory. Furthermore, the brightness-enhancing effect is still unsatisfactory, for the planar light-transmitting areas between larger protrusions and smaller protrusions are large.

### SUMMARY OF THE INVENTION

The primary objective of the present invention is to provide a brightness enhancement film with enhanced light gathering effect, enhanced light-gathering uniformity, enhanced diffusion effect, reduced light leakage, reduced thickness, and reduced costs.

A brightness enhancement film according to the preferred teachings of the present invention includes a substrate, a plurality of light-gathering units, and a plurality of micro-lenses. The substrate includes a first surface and a second surface that is opposite the first surface. The light-gathering units are mounted on the first surface, with the light-gathering units being aligned and spaced from each other in a first direction to form columns of the light-gathering units and the columns being arranged in a second direction to form a matrix of the light-gathering units, with each of the light-gathering units including a top face and a plurality of stepped portions on a peripheral surface of the light-gathering unit between the top face and the first surface. And the micro-lenses mounted on the first surface, with each of the micro-lenses being located between two adjacent light-gathering units in the first direction and between another two adjacent light-gathering units in the second direction.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a top plan view of a brightness enhancement film of a first embodiment according to the preferred teachings of the present invention.

FIG. 2 shows a cross sectional view of an example of the brightness enhancement film of FIG. 1.

FIG. 3 shows a cross sectional view of another example of the brightness enhancement film of FIG. 1.

FIG. 4 shows a top plan view of a brightness enhancement film of a second embodiment according to the preferred teachings of the present invention.

FIG. 5 shows a cross sectional view of the brightness enhancement film of FIG. 4.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “outermost”, “portion”, “axial”, “outward”, “length”, “width”, “height”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

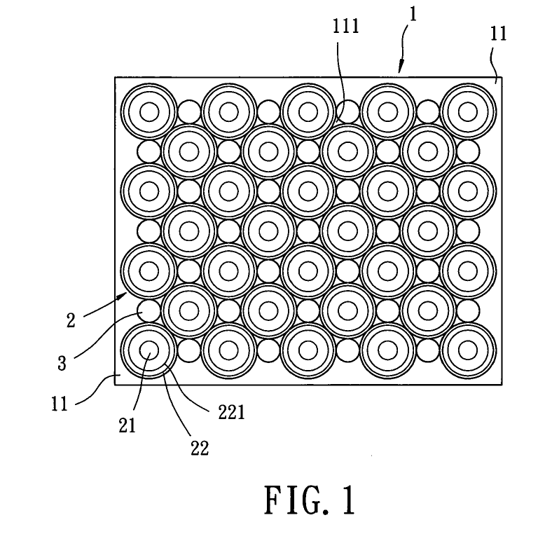

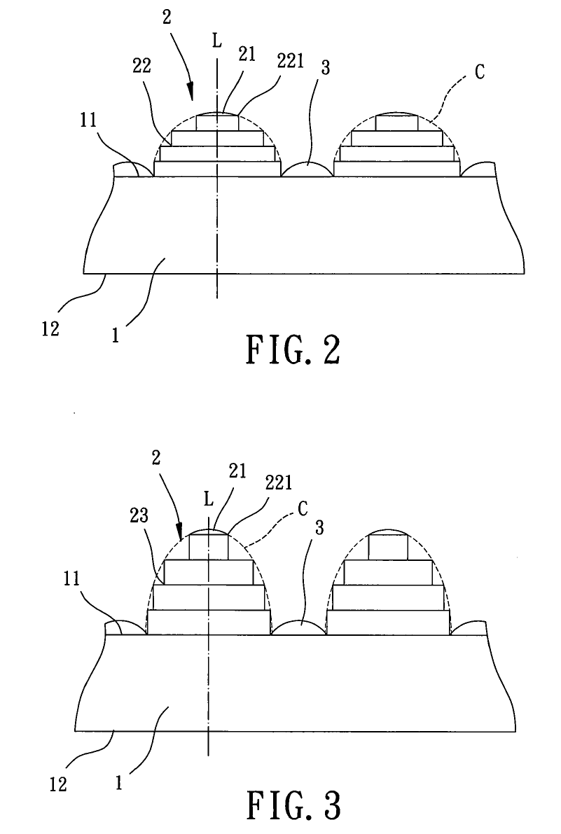

A brightness enhancement film of a first embodiment according to the preferred teachings of the present invention is shown in FIGS. 1 and 2 of the drawings. According to the preferred form shown, the brightness enhancement film includes a substrate 1, a plurality of light-gathering units 2, and a plurality of micro-lenses 3.

According to the preferred form shown, the substrate 1 includes a first surface 11 on which the plurality of light-gathering units 2 are arranged and a second surface 12 that is substantially flat or planar and opposite the first surface 11.

According to the preferred form shown, the light-gathering units 2 are arranged in a matrix on the first surface 11. Specifically, light-gathering units 2 are aligned and spaced from each other in a first direction to form a column of light-gathering units 2 while columns of light-gathering units 2 are arranged in a second direction to form the matrix of light-gathering units 2, with the second direction being perpendicular to the first direction. A plurality of areas 111 uncovered by light-gathering units 2 is left on the first surface 11. Specifically, two adjacent light-gathering units 2 in the first direction have an uncovered area 111 therebtween, and two adjacent light-gathering units 2 in the second direction also have an uncovered area 111 therebetween. Note that, by examining the matrix of light-gathering units 2 along the second direction, light-gathering units 2 in one of the columns are misaligned with light-gathering units 2 in an adjacent column, such that each light-gathering unit 2 in a column is aligned with one of the uncovered areas 111 in the adjacent column. Each light-gathering unit 2 is inscribed in a hemispherical surface, a parabolic surface, or a conical surface (a peripheral surface of a cone or a truncated cone).

According to the preferred form shown, each light-gathering unit 2 includes a top face 21 and a plurality of stepped portions 22. The top face 21 can be a planar surface or a curved surface including a parabolic surface, a hemispherical surface, or a conical surface. In the example shown in FIG. 2, the top face 21 is a parabolic surface to further increase the light diffusion effect. The stepped portions 22 are formed on a peripheral surface between the top face 21 and the first surface 11, so that each light-gathering unit 2 includes a multi-layer structure. Each stepped portion 22 includes a peripheral edge 221 that is a radially outer edge of the stepped portion 22. The peripheral edges 221 of the stepped portions 22 of each light-gathering unit 2 are inscribed in a hemispherical surface or a parabolic surface. Specifically, on a plane including a central, axial line L of each light-gathering unit 2, the intersections of the peripheral edge 221 of each stepped portion 22 and the plane are located on a curve C symmetric to the central, axial line L. In the example shown in FIG. 2, the curve C is semi-circular. In the example shown in FIG. 3, the curve C is parabolic.

According to the preferred form shown, since the peripheral edges 221 of the stepped portions 22 of each light-gathering unit 2 are inscribed in a hemispherical surface or a parabolic surface, the peripheral edge 221 of each stepped portion 22 is circular, and each light-gathering unit 2 has increasing widths from the top face 21 toward the first surface 11. Furthermore, since each stepped portion 22 is symmetric to the central, axial line L, diffusion occurs when light passes through each light-gathering unit 2. Thus, the stepped portions 22 reduce loss of light. As a result, the light-concentrating effect, the light-gathering capability, and the overall brightness are enhanced. For every light-gathering unit 2, the stepped portions 22 are of the same height in the preferred form shown. However, the stepped portions 22 of the same light-gathering unit 2 can have different heights according to different light-gathering needs.

Each micro-lens 3 is a lens having a hemispherical surface or a non-hemispherical surface such as a parabolic surface. Each micro-lens 3 is mounted in one of the uncovered areas 111. Each light-gathering unit 2 in a column is aligned with one of the micro-lenses 3 in an adjacent column. Thus, the light-gathering units 2 and the micro-lens 3 are alternately arranged in each column and row of the matrix. Furthermore, each micro-lens 3 is contiguous with adjacent light-gathering units 2 surrounding the micro-lens 3 to reduce the uncovered areas 111. Preferably, each micro-lens 3 has a diameter smaller than the diameter of an outermost, circular, peripheral edge 221 of each light-gathering unit 2. Since the micro-lenses 3 provide a light diffusion effect, when the brightness enhancement film according to the preferred teachings of the present invention is utilized in a backlight module, the backlight module does not have to include a diffusion film. Thus, the overall thickness of the backlight module can be reduced, and the costs of the backlight module are cut.

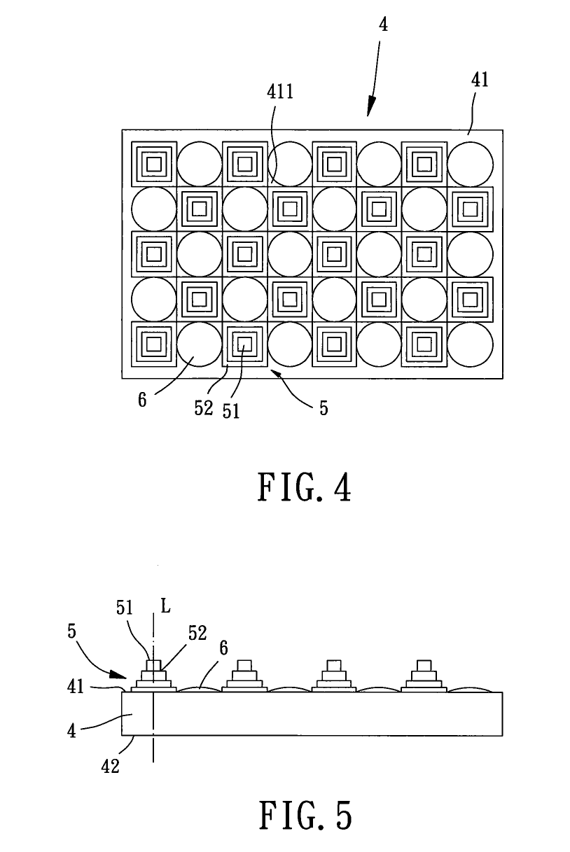

FIGS. 4 and 5 show a brightness enhancement film of a second embodiment according to the preferred teachings of the present invention. According to the preferred form shown, the brightness enhancement film includes a substrate 4, a plurality of light-gathering units 5, and a plurality of micro-lens 6. The substrate 4 includes a first surface 41 and a second surface 42.

According to the preferred form shown, the light-gathering units 5 are arranged in a matrix on the first surface 41. Specifically, light-gathering units 5 are aligned and spaced from each other in the first direction to form a column of light-gathering units 5 while columns of light-gathering units 5 are arranged in a second direction to form the matrix of light-gathering units 5, with the second direction being perpendicular to the first direction. A plurality of areas 411 uncovered by light-gathering units 5 are left on the first surface 41. Specifically, two adjacent light-gathering units 5 in the first direction have an uncovered area 411 therebtween, and two adjacent light-gathering units 5 in the second direction have an uncovered area 411 therebetween. Note that, by examining the matrix of light-gathering units 5 along the second direction, the light-gathering units 5 in two adjacent columns of light-gathering units 5 are misaligned, such that each light-gathering unit 5 in a column is aligned with one of the uncovered areas 411 in an adjacent column. Each light-gathering unit 5 is inscribed in a square pyramidal surface.

According to the preferred form shown, each light-gathering unit 5 includes a top face 51 and a plurality of stepped portions 52. The top face 51 is a planar surface. The stepped portions 52 are formed on a peripheral surface between the top face 51 and the first surface 41, so that each light-gathering unit 5 includes a multi-layer structure. Each stepped portion 52 includes a peripheral edge 521 that is a outer edge of the stepped portion 52, with the peripheral edge 521 being inscribed in a pyramidal surface, in this embodiment, the peripheral edges 521 of each light-gathering unit 5 are inscribed in a square pyramidal surface. The peripheral edge 521 of each stepped portion 52 is square in the preferred form shown. However, the peripheral edge 521 of each stepped portion 52 can be rectangular. Each step of the stepped portions 52 of the same light-gathering unit 5 can have different heights.

Each micro-lens 6 is mounted in one of the areas 411. Each light-gathering unit 5 in a column is aligned with one of the micro-lenses 3 in an adjacent column. Thus, the light-gathering units 5 and the micro-lens 6 are alternately arranged in each column and row of the matrix. Furthermore, each micro-lens 6 is contiguous with adjacent light-gathering units 5 to reduce the uncovered areas 411. Preferably, each micro-lens 6 has a diameter being the same as the edge length of the outermost, square, peripheral edge 521 of each light-gathering unit 5. Since the micro-lenses 6 provide a light diffusion effect, when the brightness-enhancement film according to the preferred teachings of the present invention is utilized in a backlight module, the backlight module does not have to include a diffusion film. Thus, the overall thickness of the backlight module can be reduced, and the costs of the backlight module are cut.

The brightness enhancement film according to the preferred teachings of the present invention can be made of resin, plastic, or optical glass. The brightness enhancement film according to the preferred teachings of the present invention provides enhanced light-gathering uniformity by the arrangement of the array of light-gathering units 2, 5 on the substrate 1, 4. Furthermore, the brightness enhancement film according to the preferred teachings of the present invention provides an enhanced light-gathering effect by providing stepped portions 22, 52 on the peripheral surface of each light-gathering unit 2, 5. Further, the brightness enhancement film according to the preferred teachings of the present invention provides a light diffusion effect and reduced light leakage by providing micro-lenses 3, 6 on the uncovered areas 111, 411.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A brightness enhancement film comprising:
a substrate including a first surface and a second surface that is opposite the first surface;
a plurality of light-gathering units mounted on the first surface, wherein the light-gathering units are aligned and spaced from each other in a first direction to form a column of the light-gathering units and the columns are arranged in a second direction to form a matrix of the light-gathering units, each of the light-gathering units includes a top face and a plurality of stepped portions on a peripheral surface of the light-gathering unit between the top face and the first surface; and
a plurality of micro-lenses mounted on the first surface, wherein each of the micro-lenses is located between two adjacent light-gathering units in the first direction and between another two adjacent light-gathering units in the second direction.

2. The brightness enhancement film as claimed in claim 1, wherein each of the micro-lenses is contiguous with the light-gathering units surrounding the micro-lens.

3. The brightness enhancement film as claimed in claim 1, wherein each of the light-gathering units includes a central, axial line, and the plurality of stepped portions are symmetric to the central, axial line.

4. The brightness enhancement film as claimed in claim 1, wherein each of the stepped portions of each of the light-gathering units includes a peripheral edge having a plurality of intersections with a plane including a central, axial line of the light-gathering unit, and the intersections are located on a curve symmetric to the central, axial line.

5. The brightness enhancement film as claimed in claim 1, wherein the stepped portions of each of the light-gathering units form a multi-layer structure, and each of the light-gathering units is inscribed in a hemispherical surface, parabolic surface, conical surface or pyramidal surface, and each of the stepped portions of each of the light-gathering units includes a peripheral edge that is circular, square or rectangular.

6. The brightness enhancement film as claimed in claim 5, wherein the peripheral edge of each of the stepped portions is square, and each of the micro-lens has a diameter the same as an edge length of an outermost one of the square, peripheral edges of each of the light-gathering units.

7. The brightness enhancement film as claimed in claim 5, wherein each of the stepped portions of each of the light-gathering units includes a circular, peripheral edge, and each of the micro-lens has a diameter smaller than that of an outermost one of the circular, peripheral edges of each of the light-gathering units.

8. The brightness enhancement film as claimed in claim 1, wherein the top face of each of the light-gathering units is a planar surface or a curved surface.

9. The brightness enhancement film as claimed in claim 8, wherein the curved face is a hemispherical surface, a parabolic surface or a conical surface.

10. The brightness enhancement film as claimed in claim 1, wherein the stepped portions of each of the light-gathering units have an identical height.

11. The brightness enhancement film as claimed in claim 1, wherein the stepped portions of each of the light-gathering units have different heights.

12. The brightness enhancement film as claimed in claim 1, wherein each of the micro-lenses is a hemispherical lens.

13. The brightness enhancement film as claimed in claim 1, wherein each of the micro-lenses is a non-hemispherical lens having a parabolic surface.

14. The brightness enhancement film as claimed in claim 1, wherein the brightness enhancement film is made of one of resin, plastic, and optical glass.

15. The brightness enhancement film as claimed in claim 1, wherein each of the light-gathering units has increasing widths from the top face toward the first surface.

16. The brightness enhancement film as claimed in claim 1, wherein each of the light-gathering units in one of the columns is aligned with one of the micro-lenses in an another column adjacent to the said one of the columns, and each of the light-gathering units in one of the rows is aligned with one of the micro-lenses in an another row adjacent to the said one of the rows.
